(19) United States
(12) Patent Application Publication
(10) Pub. No.: US 2012/0260246 A1
(43) Pub. Date: Oct. 11, 2012

(54) SOFTWARE APPLICATION INSTALLATION

(75) Inventors: Sukadev Bhattiprolu, Beaverton, OR (US); Venkateswarara Jujjuri, Beaverton, OR (US); Haren Myneni, Tigard, OR (US); Malahal R. Naineni, Tigard, OR (US); Badari Pulavarty, Beaverton, OR (US); Chandra Seetharaman, Portland, OR (US); Narasimha N Sharoff, Beaverton, OR (US)

(73) Assignee: INTERNATIONAL BUSINESS MACHINES CORPORATION, Armonk, NY (US)

(21) Appl. No.: 13/081,429

(22) Filed: Apr. 6, 2011

(51) Int. Cl. G06F 9/445

(52) U.S. Cl. 717/176

(57) ABSTRACT

Systems, methods and computer program products may provide software installation on a computer in a computer system. A software installation method may include installing at a server in a computer system a first files package including computer program files for a first software application, the computer system including at least a first computer installed with a first configuration package, the first configuration package including files necessary to configure and register the first software application, receiving a request at the server from the first computer for access to the first files package, and making the first files package available for use by the first computer.

### BACKGROUND

The present invention relates generally to software application installation on a computer in a computer system, and more specifically, to installation of a software application as two or more packages for efficient sharing in a computer system.

Typically, software installation at a target computer in a computer system includes installing a software application contained in a single software package at the target computer. The installation process includes placing the software application binary or text files in a particular location in the target computer and registering or modifying existing files in the target computer. The installed software package at the target computer may be different than the installed software package at other computers in the computer system because of the modification of the software application files during installation (e.g. /etc/passwd). The target computer installed with the software application requires storage capability to store the entire software package. Additionally, if the target computer is provided with the software application from a server in the computer system, the computer system requires sufficient network bandwidth to receive the software package from the server.

A software application may also be installed at the target computer via a z/OS minidisk or the software application package may not be installed at the target computer but instead may be shared among computers in a computer network having a distributed file system (or NFS sharing). These modes of software application used by a target computer do not change/modify the target computer's base Operating System installation, or other application files, and may not update the RPM database.

### BRIEF SUMMARY

According to one embodiment of the present invention, a software installation method may include installing at a server in a computer system a first files package including computer program files for a first software application, the computer system including at least a first computer installed with a first configuration package, the first configuration package including files necessary to configure and register the first software application, receiving a request at the server from the first computer for access to the first files package and making the first files package available for use by the first computer. The software installation method may further include receiving a request at the server from a second computer in the computer system for access to the first files package, the second computer installed with the first configuration package, and making the first files package available for use by the second computer.

In another embodiment of the present invention, a software installation method may include installing a first configuration package on a first computer in a computer system, the first configuration package including files necessary to configure and register a first software program, sending from the first computer in response to a user command a request to a server in the computer system for access to a first files package installed at the server, the first files package including computer program files for the first software program; and accessing by the first computer the first files package.

In yet another embodiment of the present invention, a computer program product for software installation may include at least one computer readable storage medium having computer readable program code embodied therewith. When read by a processor, the computer readable program code may be configured to install in a memory a first files package, the first files package including computer program files for a first software application, receive a request from a first computer in a computer system coupled to the processor for access to the first files package, the first computer installed with a first configuration package including files necessary to configure and register the first software application, and make the first files package available for use by the first computer.

In yet another embodiment of the present invention, a first computer may include a processor, a memory and a software installation program. The software installation program may include a plurality of instructions stored in the memory that are executed by the processor to install a first files package including computer program files for a first software application, receive a request from a second computer for access to the first files package, the second computer being installed with a first configuration package including files necessary to configure and register the first software application, and make the first files package available for use by the second computer. The plurality of instructions may further include instructions that are executed by the processor to receive a request from a third computer for access to the first files package, the third computer being installed with the first configuration package, and make the first files package available for use by the third computer.

### BRIEF DESCRIPTION OF THE SEVERAL VIEWS OF THE DRAWINGS

FIG. 1 is a pictorial representation of an example of a computer system in which illustrative embodiments may be implemented.

FIG. 2 is a block diagram of an example of a computer in which illustrative embodiments may be implemented.

FIG. 3 is an example of a method of installing software.

FIG. 4 is an example of a method of installing software.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF cable, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

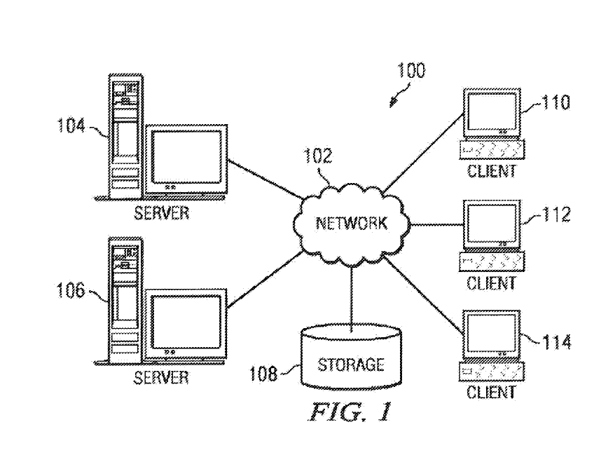

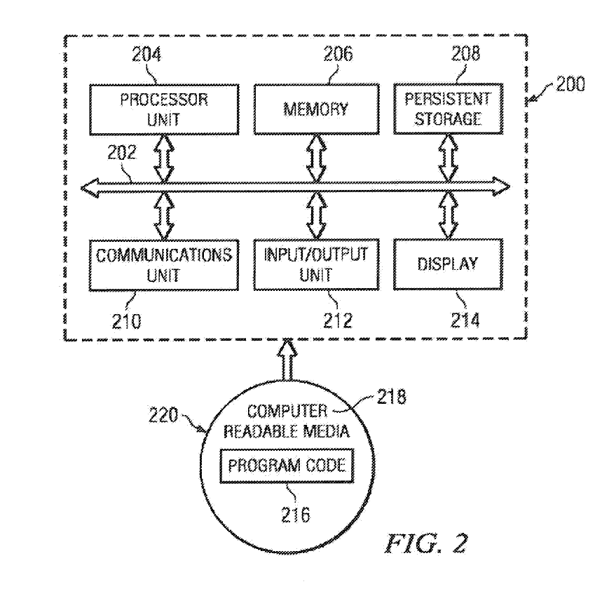

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a computer system, indicated generally at 100, and including a network of computers in which illustrative embodiments may be implemented. Computer system 100 may contain a network 102, which is the medium used to provide communications links between various devices and computers connected together within computer system 100. Network 102 may include connections, such as wire, wireless communication links, or fiber optic cables.

In the depicted example, a server 104 and a server 106 may connect to network 102 along with a storage unit 108. In addition, a first client computer 110, a second client computer 112, and a third client computer 114 may connect to network 102. Client computers 110, 112, and 114 may be, for example, personal computers or network computers. In the depicted example, server 104 may provide data, such as boot files, operating system images, and/or software applications to client computers 110, 112, and 114. Client computers 110, 112, and 114 are clients to server 104 in this example. Computer system 100 may include additional servers, clients, and other devices not shown, or may include fewer devices than those shown.

In the depicted example, network 102 may be or may include the Internet. Computer system 100 also may be implemented with a number of different types of networks, such as for example, an intranet, a local area network (LAN), or a wide area network (WAN). FIG. 1 is intended as an example, and not as an architectural limitation for the different illustrative embodiments.

A first software application may include two software packages, for example a first files package and a first configuration package, each of which may be installed on separate devices within computer system 100. For example, the first files package may be installed at server 104 and the first configuration package may be installed at one or more of client computers 110, 112 and/or 114. Server 104 may provide one or more of client computers 110, 112 and/or 114 access to the first files package. It should be appreciated that in other embodiments, the first software application may include more than two software packages. Additionally and/or alternatively, one or all of the software packages may be installed on multiple devices in the computer system 100. Each package may also include one or more sub-packages that when combined form the files package or the configuration package.

The first files package may include all of the files necessary for operation of the first software application and/or file placement. The first configuration package may include all of the tools/scripts necessary to configure and register the first software application so that the first software application may be used by the client computer. In some embodiments, the first configuration package may include everything except for file placement. The first configuration package may be smaller or “thinner” than the first files package.

For example, the first configuration package may include:

1. Any symbolic links that are needed in /bin or /usr/bin etc.;

2. Updates to a database that shows what applications are installed;
a. In the Red Hat Enterprise Linux (RHEL) and/or SuSE Linux Enterprise Server (SLES) operating systems it is the .rpm database;
b. In the Windows operating system it is the System Registry;

3. Simple additions to existing files. For example, adding user peripheral or network devices, such as adding “canonprinter” to /etc/passwd for a printer;

4. Scripts that change some files in a root file system;

5. Code for starting services like /etc/init.d/<service>;

6. Node/guest specific configuration files.

The first files package and the first configuration package may be run and/or installed at separate devices in computer system 100 at different times. However, the first software application may not be useable by a client computer without access to or installation of both the first files package and the first configuration package. For example, the first software application may not be useable by a client computer if one of the following conditions are not met:

1) the client computer does not have the first configuration package installed; or

2) the client computer is not provided access to the first files package installed at a server.

As noted above, one or all of client computers 110, 112 and/or 114 may have the first configuration packaged stored and/or installed. The first files package may be maintained and/or installed at server 104. Server 104 may provide access to the first files package to one or all of client computers 110, 112, and/or 114 via network 102 by making the first files package available for use by the client computer from whom the request for access is received. A client computer having both the first configuration package installed and access to the first files package is able to use the first software application.

For example, first client computer 110 and second client computer 112 may each have the first configuration package installed, however first client computer 110 and second client computer 112 may not use the first software application without access to the first files package. Access to the first files package may be provided by server 104. A request for access to the first files package may be sent from first client computer 110 in response to a user command and may be received at server 104. In response to the request, server 104 may make the first files package available for use by first client computer 110. First client computer 110 may then access the first files package and use the first software application.

Additionally and/or alternatively, a request for access to the first files package may be sent from second client computer 112 in response to a user command and may be received at server 104. In response to the request, server 104 may additionally make the first files package available for use by second client computer 112. Second client computer 112 may then access the first files package and use the first software application.

Accordingly, the first files package installed at server 104 may be efficiently shared among devices in computer system 100, here first and second client computers 110, 112. Furthermore, the storage requirements of first and second client computers 110, 112 and the bandwidth used by first and second client computers 110, 112 may be reduced because first and second client computers 110, 112 are not required to install first files package. Additionally, the time required to install the first configuration package may be less than the time required to install the full software application and/or the time required to remove the first configuration package may be less than the time required to remove the full software application.

A second software application may include two or more software packages, such as a second files package and a second configuration package, each of which may be installed on separated devices in computer system 100. For example, the second files package may be installed at server 104 and the second configuration package may be installed at one or more client computers 110, 112 and/or 114. Server 104 may provide one or more client computers 110, 112 and/or 114 access to the second files package.

The second files package may include all of the files necessary for operation of the second software application and/or file placement. The second configuration package may include all of the tools/scripts necessary to configure and register the second software application so that the second software application may be used by a client computer.

In one embodiment of the present disclosure, third client computer 114 may have the first configuration package and the second configuration package installed. As described above, server 104 may have the second files package installed, in addition to having the first files package installed. In response to a request for access from third client computer 114, server 104 may make the first files package and the second files package available for use by third client computer 114. Third client computer 114 may then access the first files package and the second files package and, accordingly, may use the first software application and the second software application.

In one example of sharing software images among different virtual guests in a virtual environment, the virtual environment may include three guests, guest1, guest2 and guest3, and a computer node that provisions the guests. Guest1 may require RHEL-base distribution and DB2 software. Guest2 may require RHEL-base distribution and WebSphere Application Software. Guest3 may require RHEL-base distribution, DB2 software and WebSphere Application Software.

The DB2 software may include a DB2 files package and a DB2 configuration package. The WebSphere Application Software may include a WebSphere Application Software files package and a WebSphere Application Software configuration package.

The compute node that provisions the guests may be loaded with an RHEL image, a DB2 files package image, a WebSphere Application Software files package image, as well as the DB2 configuration package and a WebSphere Application Software configuration package.

Guest1 may be booted with an RHEL and DB2 files package writeable snapshot image. The DB2 configuration package may be installed at guest1 after guest1 is booted. Guest 2 may be booted with an RHEL and WebSphere Application Software files package writeable snapshot image and the WebSphere Application Software configuration package may be installed after booting guest2. Guest3 may be booted with an RHEL, DB2 files package and WebSphere Application Software files package writeable snapshot image. The DB2 configuration package and WebSphere Application Software configuration package may be installed at Guest3.

In this example, there may be no need to create an image for each application stack as RHEL, the DB2 files package and the WebSphere Application Software files package have separate file sets and do not share any file. The individual application images may be combined using snapshot, unionFS or plain separate mount techniques. The application stack image may be constructed from the individual application files packages and the configuration packages may be run after booting the guest for the first time.

In a further example, one or more software applications may be shared among different systems in a network including a central server. The central server may be installed with software application files packages, such as the DB2 files package and the WebSphere Application Software files package. The software application files packages may be shared by the different systems over Network Files System (NFS) or other means. The software application configuration packages, such as the DB2 configuration package and the WebSphere Application Software configuration package, may be individually installed on each system. The install process for each system may be faster than installing a complete software application and disk space may be saved, as the software application files packages are shared from a central server. Additionally, the removal process for each system may be faster than removing a complete software application.

With reference now to FIG. 2, a block diagram of a data processing system is shown in which illustrative embodiments may be implemented. Data processing system 200 is an example of a computer, such as server 104 or client computer 110 in FIG. 1, in which computer-usable program code or instructions implementing the processes may be located for the illustrative embodiments. In this illustrative example, data processing system 200 includes communications fabric 202, which provides communications between a processor unit 204, a memory 206, a persistent storage 208, a communications unit 210, an input/output (I/O) unit 212, and display 214. In other examples, a data processing system may include more or fewer devices.

Processor unit 204 may serve to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. For example, communications unit 210 may be a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 displays information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer-usable program code, or computer-readable program code that may be read and executed by a processor in processor unit 204. The program code in the different embodiments may be embodied on different physical or tangible computer-readable media, such as memory 206 or persistent storage 208.

Program code 216 may be located in a functional form on a computer-readable media 218 that is selectively removable and may be loaded onto or transferred to data processing system 200 for execution by processor unit 204. Program code 216 and computer-readable media 218 form computer program product 220 in these examples. In one example, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 also may take the form of a persistent storage, such as a hard drive, a thumb drive, or a flash memory that is connected to data processing system 200. The tangible form of computer-readable media 218 is also referred to as computer-recordable storage media. In some instances, computer-recordable media 218 may not be removable.

Alternatively, program code 216 may be transferred to data processing system 200 from computer-readable media 218 through a communications link to communications unit 210 and/or through a connection to input/output unit 212. The communications link and/or the connection may be physical or wireless in the illustrative examples. The computer-readable media also may take the form of non-tangible media, such as communications links or wireless transmissions containing the program code. The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. As one example, a storage device in data processing system 200 is any hardware apparatus that may store data. Memory 206, persistent storage 208, and computer-readable media 218 are examples of storage devices in tangible forms.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that maybe present in communications fabric 202.

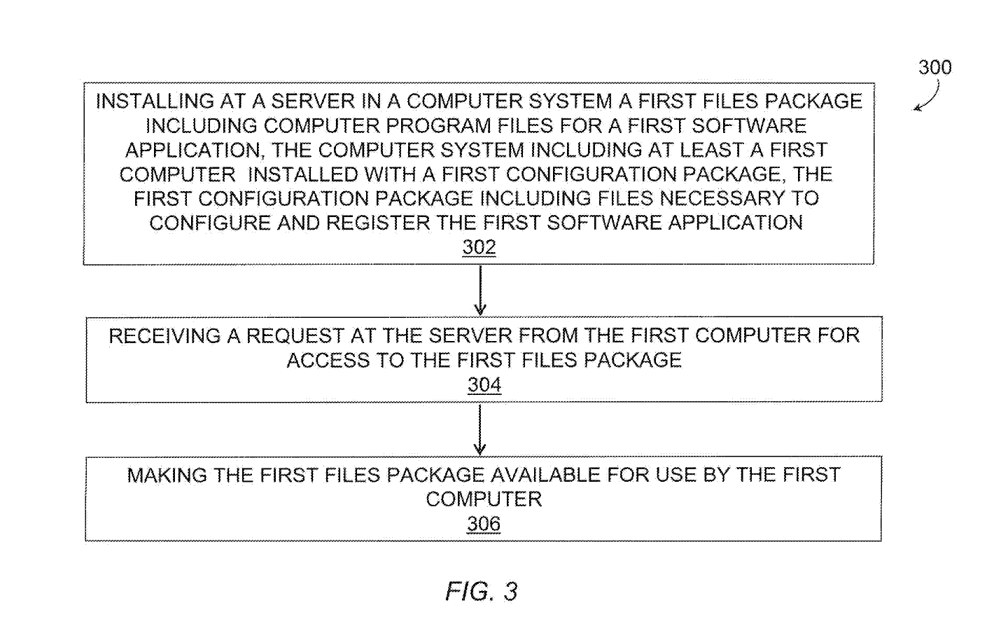

Referring now to FIG. 3, an example of a software installation method is shown. While FIG. 3 shows exemplary steps of a method according to one embodiment, other embodiments may omit, add to, and/or modify any of the steps shown in that figure. In step 302, a first files package may be installed at a server in a computer system. The first files package may include computer program files for a first software application. In addition to the server, the computer system may include at least a first computer installed with a first configuration package, the first configuration package including files necessary to configure and register the first software application. In step 304, a request may be received at the server from the first computer for access to the first files package. In step 306, the first files package may be made available for use by the first computer.

Method 300 may include other steps. For example, method 300 may include receiving a request at the server from a second computer in the computer system for access to the first files package, wherein the second computer may be installed with the first configuration package, and further making the first files package available for use by the second computer.

Furthermore, method 300 may include installing at the server a second files package including computer program files for a second software application. A request may be received at the server from a second computer in the computer system for access to the first files package and the second files package, the second computer installed with the first configuration package and a second configuration package. The second configuration package may include files necessary to configure and register the second software application. Method 300 may further include making the first files package and the second files package available for use by the second computer. Additionally, method 300 may include receiving a request at the server from the first computer for access to the second files package, the first computer installed with the second configuration package and making the second files package available for use by the first computer.

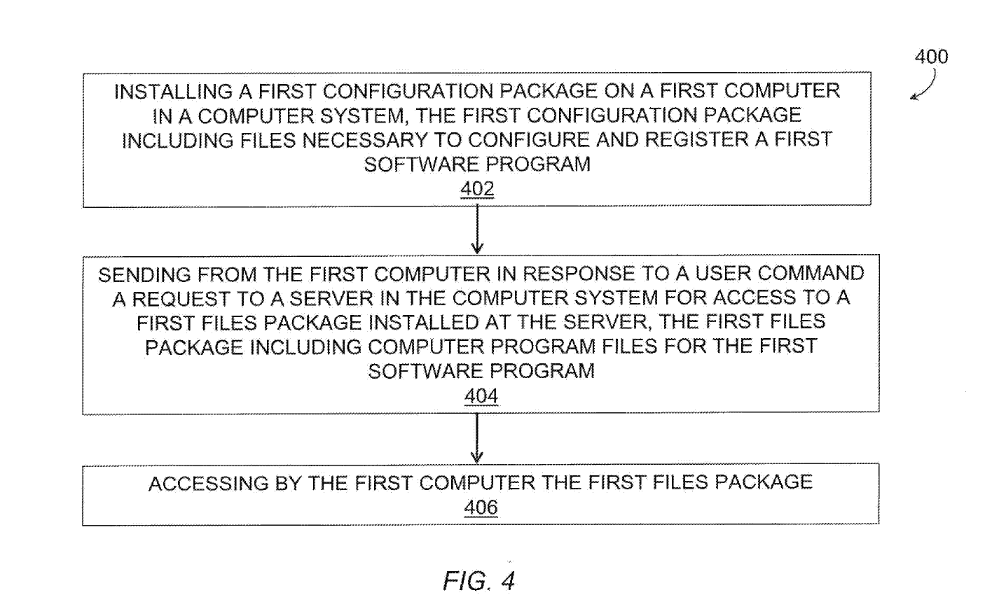

Referring now to FIG. 4, a further example of a software installation method is shown. While FIG. 4 shows exemplary steps of a method according to one embodiment, other embodiments may omit, add to, and/or modify any of the steps shown in that figure. In step 402, a first configuration package may be installed on a first computer in a computer system, the first configuration package including files necessary to configure and register a first software program. In step 404, a request to a server in the computer system may be sent from the first computer, in response to a user command, for access to a first files package installed at the server. The first files package may include computer program files for the first software program. In step 406, the first computer may access the first files package. Accessing the first files package installed at the server may include booting the first computer with the first files package.

Method 400 may include other steps. For example, method 400 may include installing the first configuration package on a second computer in the computer system, sending from the second computer in response to a user command a request to the server for access to the first files package and accessing by the second computer the first files package.

Method 400 may further include installing a second configuration package on the first computer. The second configuration package may include files necessary to configure and register a second software program. The first computer may send, in response to a user command, a request to the server for access to a second files package installed at the server, the second files package including computer program files for the second software program. The first computer may access the second files package.

Additionally, method 400 may include installing the first configuration package on a second computer in the computer system. A second configuration package may be installed on the second computer, the second configuration package including files necessary to configure and register a second software program. The second computer may send, in response to a user command, a request to the server for access to the first files package and a second files package installed at the server, the second files package including computer program files for the second software program. The second computer may access the first files package and the second files package.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A software installation method, comprising:
installing at a server in a computer system a first files package including computer program files for a first software application, the computer system including at least a first computer installed with a first configuration package, the first configuration package including files necessary to configure and register the first software application;
receiving a request at the server from the first computer for access to the first files package; and
making the first files package available for use by the first computer.

2. The method of claim 1, further comprising:
receiving a request at the server from a second computer in the computer system for access to the first files package, the second computer installed with the first configuration package; and
making the first files package available for use by the second computer.

3. The method of claim 1, further comprising:
installing at the server a second files package including computer program files for a second software application;
receiving a request at the server from a second computer in the computer system for access to the first files package and the second files package, the second computer installed with the first configuration package and a second configuration package, the second configuration package including files necessary to configure and register the second software application; and
making the first files package and the second files package available for use by the second computer.

4. The method of claim 3, further comprising:
receiving a request at the server from the first computer for access to the second files package, the first computer installed with the second configuration package; and
making the second files package available for use by the first computer.

5. A software installation method, comprising:
installing a first configuration package on a first computer in a computer system, the first configuration package including files necessary to configure and register a first software program;
sending from the first computer in response to a user command a request to a server in the computer system for access to a first files package installed at the server, the first files package including computer program files for the first software program; and
accessing by the first computer the first files package.

6. The method of claim 5, wherein accessing the first files package installed at the server includes booting the first computer with the first files package.

7. The method of claim 5, further comprising:
installing the first configuration package on a second computer in the computer system;
sending from the second computer in response to a user command a request to the server for access to the first files package; and
accessing by the second computer the first files package.

8. The method of claim 5, further comprising:
installing a second configuration package on the first computer, the second configuration package including files necessary to configure and register a second software program;
sending from the first computer in response to a user command a request to the server for access to a second files package installed at the server, the second files package including computer program files for the second software program; and
accessing by the first computer the second files package.

9. The method of claim 5, further comprising:
installing the first configuration package on a second computer in the computer system;
installing a second configuration package on the second computer, the second configuration package including files necessary to configure and register a second software program;
sending from the second computer in response to a user command a request to the server for access to the first files package and a second files package installed at the server, the second files package including computer program files for the second software program; and
accessing by the second computer the first files package and the second files package.

10. A computer program product for software installation, the computer program product comprising:
at least one computer readable storage medium having computer readable program code embodied therewith, the computer readable program code, when read by a processor, configured to:
install in a memory a first files package, the first files package including computer program files for a first software application;
receive a request from a first computer in a computer system coupled to the processor for access to the first files package, the first computer installed with a first configuration package including files necessary to configure and register the first software application; and
make the first files package available for use by the first computer.

11. The computer program product of claim 10 wherein the computer readable program code, when read by a processor, is further configured to:
receive a request from a second computer in the computer system for access to the first files package, the second computer installed with the first configuration package; and
make the first files package available for use by the second computer.

12. The computer program product of claim 10, wherein the computer readable program code, when read by a processor, is further configured to:
install in the memory a second files package including computer program files for a second software application;
receive a request from the first computer for access to the second files package, the first computer installed with a second configuration package including files necessary to configure and register the second software application; and
make the second files package available for use by the first computer.

13. The computer program product of claim 12, wherein the computer readable program code, when read by a processor, is further configured to:
receive a request from a second computer in the computer system for access to the first files package, the second computer installed with the first configuration package; and
make the first files package available for use by the second computer.

14. The computer program product of claim 12, wherein the computer readable program code, when read by a processor, is further configured to:
receive a request from a second computer in the computer system for access to the first files package and the second files package, the second computer installed with the first configuration package and the second configuration package; and
make the first files package and the second files package available for use by the second computer.

15. A first computer, comprising:
a processor;
a memory; and
a software installation program including a plurality of instructions stored in the memory that are executed by the processor to:
install a first files package including computer program files for a first software application;
receive a request from a second computer for access to the first files package, the second computer installed with a first configuration package including files necessary to configure and register the first software application; and
make the first files package available for use by the second computer.

16. The first computer of claim 15, wherein the plurality of instructions further includes instructions that are executed by the processor to:
receive a request from a third computer for access to the first files package, the third computer installed with the first configuration package; and
make the first files package available for use by the third computer.

17. The first computer of claim 15, wherein the plurality of instructions further includes instructions that are executed by the processor to:
install a second files package including computer program files for a second software application;
receive a request from the second computer for access to the second files package, the second computer installed with a second configuration package including files necessary to configure and register the second software application; and
make the second files package available for use by the second computer.

18. The first computer of claim 17, wherein the plurality of instructions further includes instructions that are executed by the processor to:
receive a request from a third computer for access to the first files package, the third computer installed with the first configuration package; and
make the first files package available for use by the third computer.

19. The first computer of claim 17, wherein the plurality of instructions further includes instructions that are executed by the processor to:
receive a request from a third computer for access to the first files package and the second files package, the third computer installed with the first configuration package and the second configuration package; and
make the first files package and the second files package available for use by the third computer.
